(19) United States
(12) Patent Application Publication
(10) Pub. No.: US 2015/0347697 A1
(43) Pub. Date: Dec. 3, 2015

(54) COMPUTERIZED SYSTEM FOR TRACKING, MANAGING, AND ANALYZING HOSPITAL PRIVILEGES THROUGH THE USE OF SPECIFICALLY RESEARCHED CONTENT IN CONJUNCTION WITH ICD, CPT OR OTHER CODES

(71) Applicant: Vendor Credentialing Service LLC (VCS), Houston, TX (US)

(72) Inventor: James F. Cox, Franklin, TN (US)

(21) Appl. No.: 14/825,060

(22) Filed: Aug. 12, 2015

Related U.S. Application Data
(63) Continuation-in-part of application No. 14/224,436, filed on Mar. 25, 2014.
Application No. 14/224,436 is a continuation of application No. 11/890,544, filed on Aug. 7, 2007.
(60) Provisional application No. 60/836,138, filed on Aug. 8, 2006.

(51) Int. Cl. G06F 19/00

(52) U.S. Cl. CPC G06F 19/328

(57) ABSTRACT

Embodiments of systems and methods for tracking, managing, and analyzing hospital privileges through the use of specifically researched content in conjunction with ICD, CPT or other codes are described.

### CROSS-REFERENCE TO RELATED APPLICATIONS

This application is a continuation-in-part of U.S. patent application Ser. No. 14/224,436 filed on Mar. 25, 2014 entitled “computerized system for tracking, managing, and analyzing hospital privileges through the use of specifically researched content in conjunction with ICD, CPT or other codes,” which is a continuation of U.S. patent application Ser. No. 11/890,544 filed on Aug. , 2007, the disclosure and drawings of which are incorporated herein by reference in entirety. U.S. patent application Ser. No. 11/890,544 itself claims priority to provisional application 60/836,138 filed Aug. 8, 2006.

### BACKGROUND OF THE INVENTION

1. Field of the Invention

This invention relates to medical facility information and management systems and more particularly relates to systems and methods for tracking, managing, and analyzing hospital privileges through the use of specifically researched content in conjunction with ICD, CPT or other codes.

2. Description of the Related Art

Hospitals and other medical institutions are often seeking ways to increase patient safety and reduce risk. There are many systems and policies that have been developed to assist hospitals in accomplishing these goals. One of those policies is generally known as ‘core’ or ‘evidence based’ privileging.

Typically when a doctor or other health professional joins a medical staff, the hospital or other care facility must determine what the doctor will be allowed to do in that facility. For example, an ophthalmologist should not be permitted to remove a patient's appendix so, that ophthalmologist may be restricted in some way as to the procedures they would be allowed to perform. Also, inherent in some procedures, are issues of education in that specialized procedures may require training beyond minimal levels. Finally, there are several systems of ‘codes’ that are used to describe these procedures for billing purposes that can also affect the extent or even the method of performing a given set of procedures.

Until recently, there was no accepted method of controlling this list of privileges beyond simply granting the privileges that the physician requested. This has become known as the “laundry list” method because the list of the procedures normally gave no details beyond its name. The physician would simply check off the privileges he wanted. This approach naturally assumes that the physician to be self-determinant as to his own skill level and training. This policy has led to many situations in which physicians are performing procedures they are not necessarily qualified to do. Further, as some of the lines between specialties begin to blur, as in certain radiology and cardiology procedures for example, large discrepancies can be found between the two specialties in requirements to do exactly the same procedure.

A number of high profile legal cases have brought the weakness in the ‘laundry list’ methodology to the industry's attention. As a result, a new method of privileging physicians and other health care workers was created and has become generally known in the industry as ‘core privileging.’ Core privileging is essentially the process by which a list of privileges by specialty is developed and then further described by the education, special training or other requirements a physician must meet prior to the physician being granted permission to perform that procedure in the health care facility.

Unfortunately, the work necessary to create this information and its subsequent management are quite daunting and have resulted in very few health care facilities being able to implement the process. Further, even facilities with limited success in core privileging are now facing the need to further break down the descriptions of procedures into their associated procedure codes published by such entities as the World Health Organization (WHO) and the American Medical Association for examples (AMA). The effort of private enterprise to assist these health care facilities has been at best, superficial and at worst, helping to perpetuate the ‘laundry list’ approach.

In order to accomplish ‘core’ or ‘evidence based’ privileging, several pieces of information may be needed:
a) Each medical specialty should have it own set of privileges
b) Each privilege within the specialty should:
   a. be well documented and researched through reliable medical sources that are subsequently reviewed by appropriate medical panels
   b. contain a description of the basic education the physician is required to have
   c. describe a list of procedures that can be included in the physicians' basic education
   d. describe a list of ‘special’ procedures that require training or impose other limitations on performing those procedures
   e. for any ‘special’ procedure a specific set of criteria that contains:
      i. the education needed to perform the ‘special’ procedure
      ii. an description of the procedure that is adequate to determine its scope
      iii. the performance level needed to grant or renew the privilege
      iv. approval from an authorized medical entity within the facility
   f. A date that the privilege was granted and expires
c) Each privilege should be matched to one or more billing codes in order to measure the performance of each privilege.

It has historically been extremely difficult for any hospital to create and implement such a system. The barriers and obstacles faced by the industry include: 1) there is no central source that lists the privileges associated with a specialty 2) once identified, there is no central source in which to research the actually makeup of the privileges 3) billing codes have not been cross referenced to privileges and are often in conflict with privilege descriptions. These problems are compounded by the typical hospitals internal structure, lack of time on the part of physicians to devote to this topic and the strange complexity of billing codes.

There have been several attempts by the industry and private enterprise to address the shortfall in privileging. The currently available solutions fall far short of the comprehensive nature of privileging and usually only address one or two of the aspects needed to adequately manage the process

Commercially available privilege sets do not include the level of privileging detail needed or proposed nor do they include the associated billing codes or their manipulation and management. The privileges currently being offered have not been fully reviewed by an independent, qualified medical panel and hence might be questioned by doctors. Even though they are highly likely to be correct, they lack the credibility needed to quickly establish them as the standard for the industry.

Industry organizations and groups have done little in either of the areas in question. The Accreditation Council for Graduate Medical Education (ACGME) which is the body responsible for medical education, has done some work in describing some ‘core’ and ‘special’ procedures and the ‘needs’ of a process have been outlined by Joint Commission on Accreditation of Healthcare Organizations (JCAHO), which is widely recognized as the standards hospitals should follow. However, there is no single source in the industry that offers any help to hospitals in developing or managing evidence based privileging.

Private concerns have been a bit more responsive. Most companies that sell credentialing or quality software have a ‘privileging system’ however, on close examination they are merely a framework in which a hospital can put the privileging information it develops and for the most part, they do not include any detailed information and no company has included a list of corresponding billing codes.

### SUMMARY

Embodiments of systems and methods for tracking, managing, and analyzing hospital privileges through the use of specifically researched content in conjunction with ICD, CPT or other codes are described. In an embodiment, a system may include a data storage unit configured to store a dataset of predefined medical service provider privileges and a dataset of billing information, the billing information that is correlated to the predefined medical service provider privileges. Additionally, the system may include a data processor configured to: access the dataset of predefined medical service provider privileges, access the dataset of billing information, the billing information including one or more billing codes that are correlated to the predefined medical service provider privileges, assign a set of one or more of the medical service provider privileges to a medical service provider, track billing information associated with the medical service provider, and update the set of one or more of the medical service provider privileges assigned to the medical service provider in response to the billing information.

In an embodiment, the dataset of billing information includes a billing code that is correlated with the medical service provider privileges. In such an embodiment, the data processor may be configured to modify the correlation of the set of one or more billing codes with the medical service provider privileges.

Additionally, the system may include an interface for allowing a user to modify the set of one or more billing codes associated with the medical service provider privileges. In another embodiment, the system may include an interface for allowing a user to modify one or more of the medical service provider privileges.

In one embodiment, assigning the set of one or more of the medical service provider privileges further comprises assigning a default set of medical service provider privileges in response to a service provider profile. In such an embodiment, the data processor may be further configured to automatically update the default set of medical service provider privileges assigned to the service provider in response to the billing information. Additionally, the data processor may automatically track billing codes associated with the medical service provider over a period of time to determine a number of procedures and a type of procedures performed by the medical service provider.

In one embodiment, updating includes granting privileges in response to a determination that the number of procedures performed by the medical service provider exceeds a threshold number of procedures. In another embodiment, updating further comprising restricting privileges in response to a determination that the number of procedures performed by the medical service provider is below a threshold number of procedures.

In an embodiment, the data processor is further configured to automatically generate a notification in response to updating the set of one or more medical service provider privileges assigned to the medical service provider.

An embodiment of a method may include accessing a dataset of predefined medical service provider privileges stored on a data storage unit. Additionally, the method may include accessing a dataset of billing information, the billing information that is correlated to the predefined medical service provider privileges stored on a data storage unit. The method may further comprise assigning a set of one or more of the medical service provider privileges to a medical service provider with a data processor. Also, the method may include tracking billing information associated with the medical service provider with the data processor. The method may additionally include updating the set of one or more of the medical service provider privileges assigned to the medical service provider in response to the billing information with the data processor.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is a schematic block diagram illustrating one embodiment of a system for tracking, managing, and analyzing hospital privileges through the use of specifically researched content in conjunction with ICD, CPT or other codes.

FIG. 1B is a schematic block diagram illustrating one embodiment of a system for tracking, managing, and analyzing hospital privileges through the use of specifically researched content in conjunction with ICD, CPT or other codes.

FIG. 2 is a schematic block diagram illustrating one embodiment of a database system for tracking, managing, and analyzing hospital privileges through the use of specifically researched content in conjunction with ICD, CPT or other codes.

FIG. 3 is a schematic block diagram illustrating one embodiment of a computer system that may be used in accordance with certain embodiments of the system for tracking, managing, and analyzing hospital privileges through the use of specifically researched content in conjunction with ICD, CPT or other codes.

FIG. 4 is a schematic logical diagram illustrating one embodiment of abstraction layers of operation in a system for tracking, managing, and analyzing hospital privileges through the use of specifically researched content in conjunction with ICD, CPT or other codes.

FIG. 5 is a schematic block diagram illustrating one embodiment of an apparatus for tracking, managing, and analyzing hospital privileges through the use of specifically researched content in conjunction with ICD, CPT or other codes.

FIG. 6 is a schematic flowchart diagram illustrating one embodiment of a method for tracking, managing, and analyzing hospital privileges through the use of specifically researched content in conjunction with ICD, CPT or other codes.

FIG. 7 is a representation of an initial master load from Master data with local customization.

FIG. 8 is a representation of an Add or Update local user data from Master data.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present embodiments supply health care facilities with a computerized system to create, edit and manage health care worker privileges through the use of highly researched privileging information and coupled with the appropriate codes reflective of that procedure all of which are pre-loaded as part of the system and require no further intervention by the user. Additionally, the described embodiments combine elements through a computerized system that allow for the management and distribution with relative ease.

A computerized system for tracking, managing and analyzing hospital/facility privileges, may include privilege information stored on a computer readable medium identifying a comprehensive list of privileges for each medical specialty performed at a hospital/facility, each privilege being individually assignable to individual healthcare workers. Additionally, the system may include billing code information stored on the computer readable medium, said billing code information including a comprehensive list of medical billing codes, each medical billing code being assignable to one or more individual ones of said privileges. The system may further include relational information stored on the computer readable medium keeping track of medical procedures performed by said individual healthcare workers and appropriate one(s) of said medical billing codes reflective of each said medical procedure. In some embodiments, a privileging computer for generating a privilege determination for the individual healthcare workers using the privilege information, the billing code information, and the relational information is included. In such embodiments, each privilege within each medical specialty: 1) contains a description of the basic education a healthcare worker is required to have for said privilege; 2) describes a list of procedures that are included in the healthcare worker's basic education; 3) describes a list of special procedures that require training or other limitations on performing of such special procedures, including: a) additional educational requirements to perform each said special procedure; b) a description of each said special procedure; c) a performance level required to grant or renew each said special privilege to a particular one of said healthcare workers; and d) approval from an authorized medical entity within the hospital/facility. In such embodiments, each of the privileges for each medical specialty is matched to one or more of said medical billing codes related to each said privilege to measure the performance level of each said privilege. The computerized system may analyze individual healthcare worker performance level or privileging requirements by use of said relational information containing medical billing codes reflective of said performed medical procedures to assess whether said healthcare worker has reached the performance level required to be granted or have renewed one or more of said special privileges.

The medical billing information may include International Classification of Diseases (ICD) codes, Current Procedural Terminology (CPT) codes, or other medical billing codes or information. The billing codes can be very complex. There are several standards that the industry uses but currently the two most favored are CPT and ICD codes. Both systems have a great deal of overlap in their use but ICDs tend to be used more at the hospital level while CPT codes are used by outpatient facilities. There are thousands of codes and there is an entire industry dedicated to analyzing and using these codes for billing purposes; however, to date no one has used them in a privileging setting.

In certain embodiments, a system includes a local database comprising local privilege information corresponding to said privilege information, and local billing code information corresponding to said billing code information. Such an embodiment may also include an interface for editing the local database and for permitting users to modify the local privilege information and/or the local billing code information.

The privilege information may be pre-loaded in the system. In such an embodiment, the system may include a master privilege and billing code database stored on a computer readable medium, where the master privilege and billing code database includes a default set of privileges and a corresponding default set of medical billing codes. In a further embodiment, the system may include a local user privilege and billing code database stored on a computer readable medium, where the local user privilege and billing code database is formed from information stored in the master privilege and billing code database and includes a local set of privileges and a corresponding local set of medical billing codes. Such embodiments may include an interface configured to allow a local user to modify the local set of privileges and/or the corresponding local set of medical billing codes.

A database stored on a computer readable medium and adapted for use with a computerized medical privileging system is also described herein. In an embodiment, the database includes privilege information stored on a computer readable medium identifying a comprehensive list of privileges for each medical specialty performed at a hospital/facility, each privilege being individually assignable to individual healthcare workers. The database may also include billing code information stored on the computer readable medium, where the billing code information includes a comprehensive list of medical billing codes, each medical billing code being assignable to one or more individual said privileges. In an embodiment, the database further includes relational information stored on the computer readable medium keeping track of medical procedures performed by the individual healthcare workers and appropriate medical billing codes reflective of each the medical procedures. In an embodiment, each privilege within each medical specialty contains a description of the basic education a healthcare worker is required to have for said privilege. The privilege may also describe a list of procedures that are included in the healthcare worker's basic education. Additionally, the privilege describes a list of special procedures that require training or other limitations on performing of such special procedures, including: additional educational requirements to perform each said special procedure, a description of each said special procedure, a performance level required to grant or renew each said special privilege to a particular one of said healthcare workers, and approval from an authorized medical entity within the hospital/facility.

In such embodiments, each of the privileges for each medical specialty is matched to one or more of the medical billing codes related to each privilege in order to measure the performance level of each privilege to be used in assessing whether individual ones of said healthcare workers have reached the performance level required to be granted or have renewed one or more of the special privileges.

In certain embodiments, the database may include a complete set of privileges for every specialty, which may be pre-loaded in the system, and can then be easily modifiable within the system to fit local norms. Additionally, ongoing support through revision tracking and addition may be provided in some embodiments.

Advantageously, the present embodiments may include a pre-loaded database with a complete, detailed set of privileges, as described earlier, by specialty. Additional benefits include the flexibility of allowing custom editing of the list of privileges or change the education or other requirements to grant and maintain any or all of the specific privileges. For example, special privileges, those that require additional training or proctoring, may be housed in such a way as to permit the editing of those requirements. The master library of all privileges may enable a return to previous versions and/or to track version history in case of a configuration error, hardware failure, or need for backup. Additionally, privileges may be assignable to individual health care workers and the content of those privileges may be editable on an individual basis. Although a comprehensive list of ICD, CPT or other codes that are tied to individual privileges may be included in the system, the list of included ICD, CPT or other codes may be editable by the user to accommodate local norms or desired tracking. The system may also track the dates of granted and expiring privileges for greater automation of privileging operations. One further benefit, is that the system may include health care worker demographic and privileges granted data in order to provide easy identification by organization or hospital personnel, such as by a nurse in an operating room, etc. Such embodiments may also use standards to allow for information interchange with other computerized systems; such as procedure scheduling.

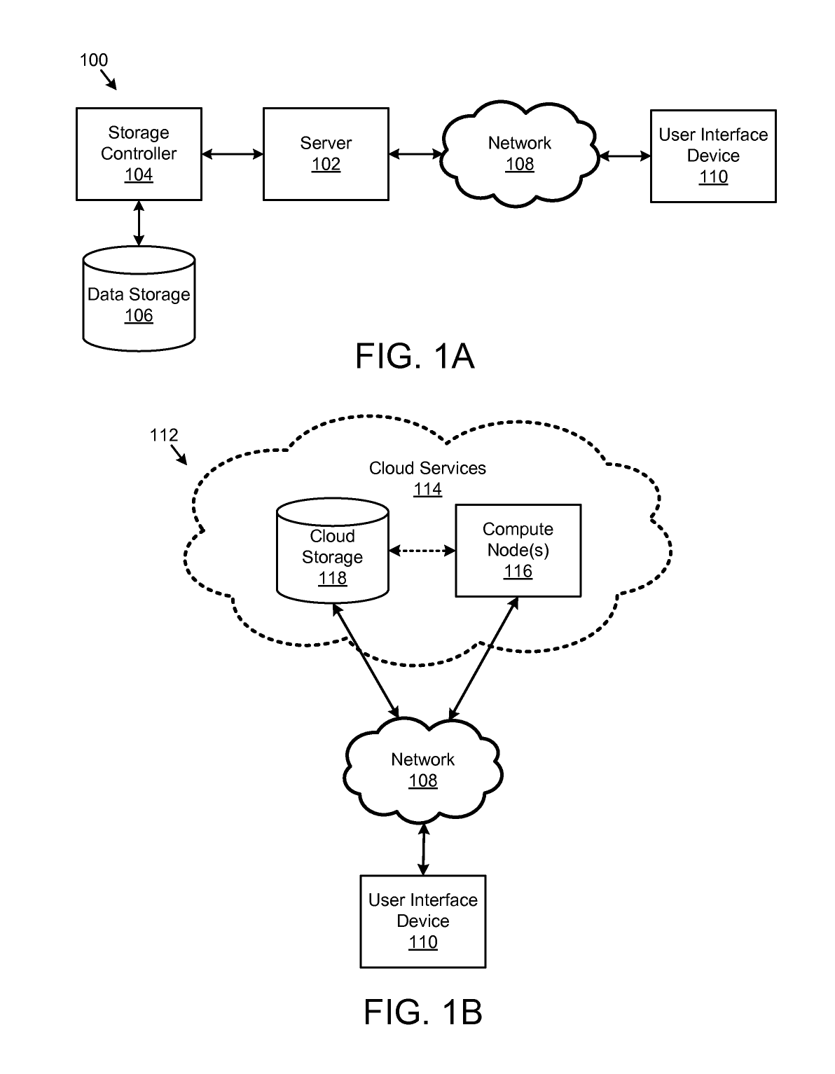

FIG. 1A illustrates one embodiment of a system 100 for tracking, managing, and analyzing hospital privileges through the use of specifically researched content in conjunction with ICD, CPT or other codes. The system 100 may include a server 102, a data storage device 104, a network 108, and a user interface device 110. In a further embodiment, the system 100 may include a storage controller 106, or storage server configured to manage data communications between the data storage device 104, and the server 102 or other components in communication with the network 108. In an alternative embodiment, the storage controller 106 may be coupled to the network 108. In a general embodiment, the system 100 may track and manage medical service provider privileges for a medical facility, such as a hospital. Specifically, the system 100 may provide a turnkey utility for allowing a hospital or other facility to select privileges from a master set of privileges, modify the privileges from the master set of privileges according to local facility requirements, assign those privileges to service providers according to the service provider's profile, track service provider procedures as reflected in billing code data, and update privileges according to certain rules or thresholds in response to the tracked billing data.

In one embodiment, the user interface device 110 is referred to broadly and is intended to encompass a suitable processor-based device such as a desktop computer, a laptop computer, a tablet computer, a Personal Digital Assistant (PDA), a mobile communication device or organizer device having access to the network 108. In a further embodiment, the user interface device 110 may access the Internet to access a web application or web service hosted by the server 102 and provide a user interface for enabling a user to enter or receive information. For example, the user may enter updates to privilege definitions by assigning certain billing codes to privileges. Additionally, the user may review requests for privilege allocation from service providers, and enter approvals or assignments of privileges. In other embodiments, the user may modify or update service provider privileges in response to billing date, and the like.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to access the dataset of predefined medical service provider privileges, access the dataset of billing information, the billing information including one or more billing codes that are correlated to the predefined medical service provider privileges, assign a set of one or more of the medical service provider privileges to a medical service provider, track billing information associated with the medical service provider, and update the set of one or more of the medical service provider privileges assigned to the medical service provider in response to the billing information. Additionally, the server 102 may access data stored in the data storage device 104 via a Storage Area Network (SAN) connection, a LAN, a data bus, or the like.

The data storage device 104 may include a hard disk, including hard disks arranged in a Redundant Array of Independent Disks (RAID) array, an optical storage device, a network attached storage drive, a local hard disk, a flash memory drive, a solid state drive, or the like. In one embodiment, the data storage device 104 may store the master privilege database, the billing code database, the privilege to billing code correlation information, the local privilege preferences database, the medical service provider profile data, and the like. The data may be arranged in a database and accessible through Structured Query Language (SQL) queries, or other data base query languages or operations.

One of ordinary skill will recognize alternative system configurations, where the data processing device is not necessarily a server. For example, the present embodiments may be loaded and executed by a stand-alone desktop computer. In another embodiment, as described in FIG. 1B, the present embodiments may be operated in a cloud computing environment, where the functions of the server 102 are performed by cloud services. While the embodiments of FIGS. 1A and 1B are provided to illustrate systems which may be suitably configured according to the present embodiments, it should be clear that the present embodiments are not limited to operation in the specific architecture described in any of FIGS. 1A-4.

FIG. 1B illustrates an example of an alternative system environment in which the present embodiments may be implemented. The system 112 of FIG. 1B may include cloud services 114. Cloud services 114 may be accessible by user interface device 110 via a network 108, and may include one or more compute nodes 116 and cloud data storage 118. One of ordinary skill will recognize a variety of platforms, architectures, and configurations for cloud services, including for example, cloud services built on an open source frameworks. One of ordinary skill will also recognize that cloud services 114 are commercially available and configurable for a variety of specific needs, including application hosting and data storage. In one embodiment, the functions described herein may be carried out by a SaaS software application hosted on the cloud services 114, and accessible by the user interface device 110. One of ordinary skill may recognize a variety of alternative embodiments, which may be equally suitable.

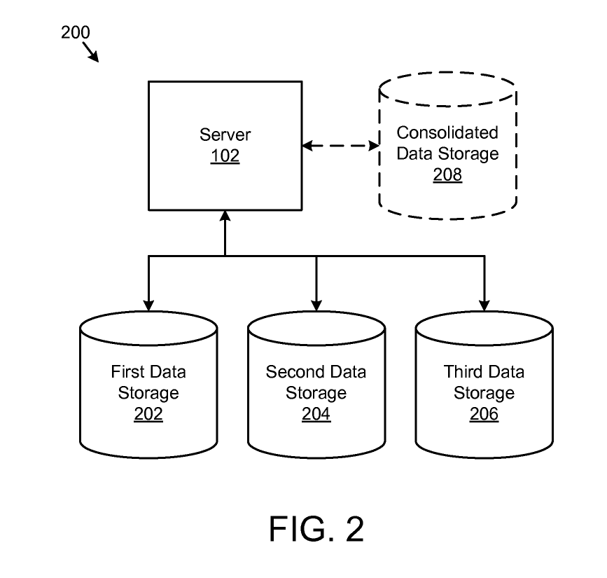

FIG. 2 illustrates one embodiment of a data management system 200 configured to store and manage data for tracking, managing, and analyzing hospital privileges through the use of specifically researched content in conjunction with ICD, CPT or other codes. In one embodiment, the system 200 may include a server 102 or a compute node 116 on cloud services 114. While the present embodiments are described generally in terms of the system 100 of FIG. 1A, one of ordinary skill will recognize that a variety of alternative embodiments may be equally suitable, including for example, the embodiment of FIG. 1B. The server 102 may be coupled to a data-bus 202. In one embodiment, the system 200 may also include a first data storage device 204, a second data storage device 206 and/or a third data storage device 208. In further embodiments, the system 200 may include additional data storage devices (not shown). In such an embodiment, each data storage device 204-208 may host a separate database of privilege data, billing data, relational data, local privilege updates or modifications, medical service provider profiles, etc. The customer information in each database may be keyed to a common field or identifier, such as a medical specialty, education level, privilege type, or the like. Alternatively, the storage devices 204-208 may be arranged in a RAID configuration for storing redundant copies of the database or databases through either synchronous or asynchronous redundancy updates.

In one embodiment, the server 102 may submit a query to selected data storage devices 204-206 to collect a consolidated set of data elements associated with an individual or group of individuals. The server 102 may store the consolidated data set in a consolidated data storage device 208 In such an embodiment, the server 102 may refer back to the consolidated data storage device 208 to obtain a set of data elements associated with a specified individual. Alternatively, the server 102 may query each of the data storage devices 202-208 independently or in a distributed query to obtain the set of data elements associated with a specified individual. In another alternative embodiment, multiple databases may be stored on a single consolidated data storage device 208.

In various embodiments, the server 102 may communicate with the data storage devices 204-208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 202-208; the server first communicating with a storage server or storage controller 106.

The server 102 may host a software application configured for tracking, managing, and analyzing hospital privileges through the use of specifically researched content in conjunction with ICD, CPT or other codes. The software application may further include modules for interfacing with the data storage devices 202-208, interfacing a network 108, interfacing with a user, and the like. In a further embodiment, the server 102 may host an engine, application plug-in, or application programming interface (API). In another embodiment, the server 102 may host a web service or web accessible software application.

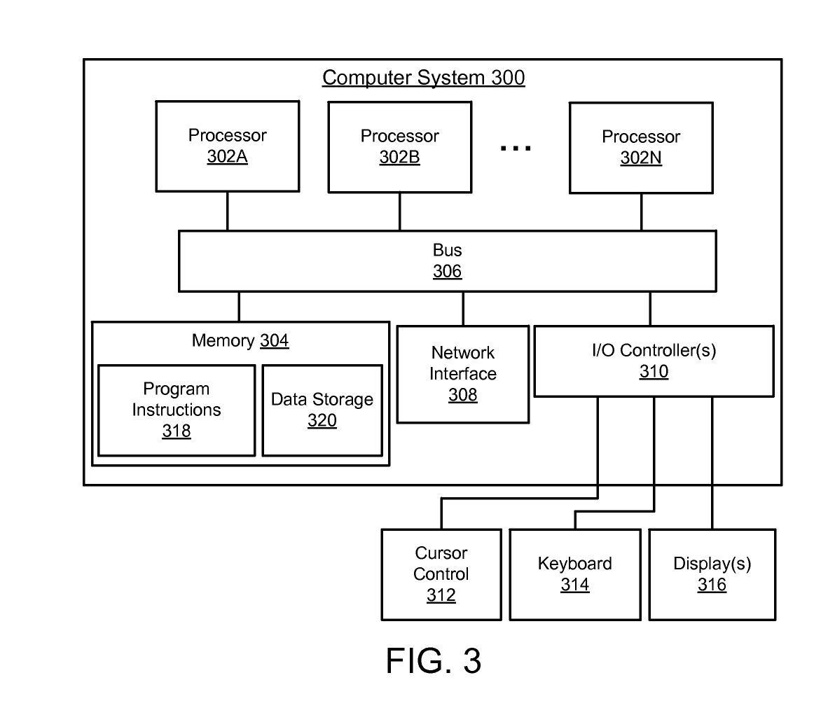

FIG. 3 is a schematic block diagram illustrating one embodiment of a computer system 300 configurable for tracking, managing, and analyzing hospital privileges through the use of specifically researched content in conjunction with ICD, CPT or other codes. In one embodiment, the server 102, the user interface device 110, and the like may be implemented on a computer system similar to the computer system 300 described in FIG. 2. Similarly, elements of the cloud services 114 may be implemented on a computer system similar to the computer system 300 described in FIG. 1B. Storage controller 106 may also be implemented on a computer system similar to the computer system 300. In various embodiments, computer system 300 may be a server, a mainframe computer system, a cloud computing system, a workstation, a network computer, a desktop computer, a laptop, or the like.

As illustrated, computer system 300 includes one or more processors 302A-N coupled to a system memory 304 via bus 306. Computer system 300 further includes network interface 308 coupled to bus 306, and input/output (I/O) controller(s) 310, coupled to devices such as cursor control device 312, keyboard 314, and display(s) 316. In some embodiments, a given entity (e.g., server 102, or user interface 110) may be implemented using a single instance of computer system 300, while in other embodiments multiple such systems, or multiple nodes making up computer system 300, may be configured to host different portions or instances of embodiments (e.g., cloud services 114).

In various embodiments, computer system 300 may be a single-processor system including one processor 302A, or a multi-processor system including two or more processors 302A-N (e.g., two, four, eight, or another suitable number). Processor(s) 302A-N may be any processor capable of executing program instructions. For example, in various embodiments, processor(s) 302A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 302A-N may commonly, but not necessarily, implement the same ISA. Also, in some embodiments, at least one processor(s) 302A-N may be a graphics processing unit (GPU) or other dedicated graphics-rendering device.

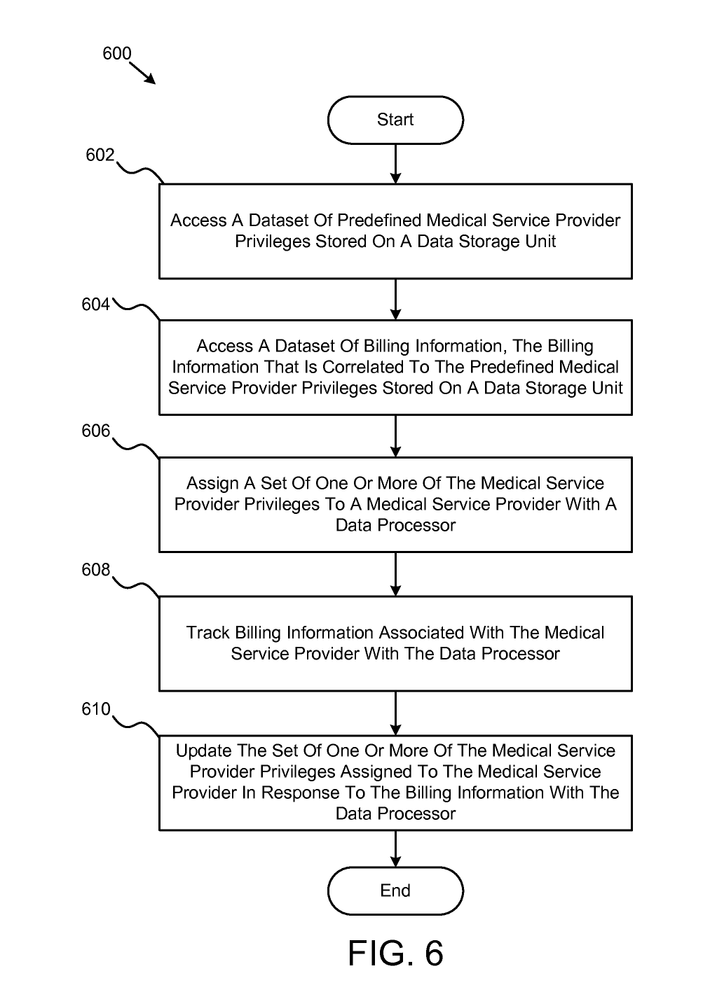

System memory 304 may be configured to store program instructions and/or data accessible by processor(s) 302A-N. For example, memory 304 may be used to store software program and/or database shown in FIGS. 6-8. In various embodiments, system memory 304 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 304 as program instructions 318 and data storage 320, respectively. In other embodiments, program instructions and/or data may be received, sent or stored upon different types of computer-accessible media or on similar media separate from system memory 304 or computer system 300. Generally speaking, a computer-accessible medium may include any tangible, non-transitory storage media or memory media such as electronic, magnetic, or optical media-e.g., disk or CD/DVD-ROM coupled to computer system 300 via bus 306, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 306 may be configured to coordinate I/O traffic between processor 302, system memory 304, and any peripheral devices including network interface 308 or other peripheral interfaces, connected via I/O controller(s) 310. In some embodiments, bus 306 may perform any necessary protocol, timing or other data transformations to convert data signals from one component (e.g., system memory 304) into a format suitable for use by another component (e.g., processor(s) 302A-N). In some embodiments, bus 306 may include support for devices attached through various types of peripheral buses, such as a variant of the Peripheral Component Interconnect (PCI) bus standard or the Universal Serial Bus (USB) standard, for example. In some embodiments, the operations of bus 306 may be split into two or more separate components, such as a north bridge and a south bridge, for example. In addition, in some embodiments some or all of the operations of bus 306, such as an interface to system memory 304, may be incorporated directly into processor(s) 302A-N.

Network interface 308 may be configured to allow data to be exchanged between computer system 300 and other devices, such as other computer systems attached to cloud services 114, for example. In various embodiments, network interface 308 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 310 may, in some embodiments, enable connection to one or more display terminals, keyboards, keypads, touch screens, scanning devices, voice or optical recognition devices, or any other devices suitable for entering or retrieving data by one or more computer system 300. Multiple input/output devices may be present in computer system 300 or may be distributed on various nodes of computer system 300. In some embodiments, similar I/O devices may be separate from computer system 300 and may interact with computer system 300 through a wired or wireless connection, such as over network interface 308.

As shown in FIG. 3, memory 304 may include program instructions 318, configured to implement certain embodiments described herein, and data storage 320, comprising various data accessible by program instructions 318. In an embodiment, program instructions 318 may include software elements of embodiments illustrated in FIGS. 6-8. For example, program instructions 318 may be implemented in various embodiments using any desired programming language, scripting language, or combination of programming languages and/or scripting languages. Data storage 320 may include data that may be used in these embodiments such as, for example, the databases described in FIG. 2. In other embodiments, other or different software elements and data may be included.

A person of ordinary skill in the art will appreciate that computer system 300 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

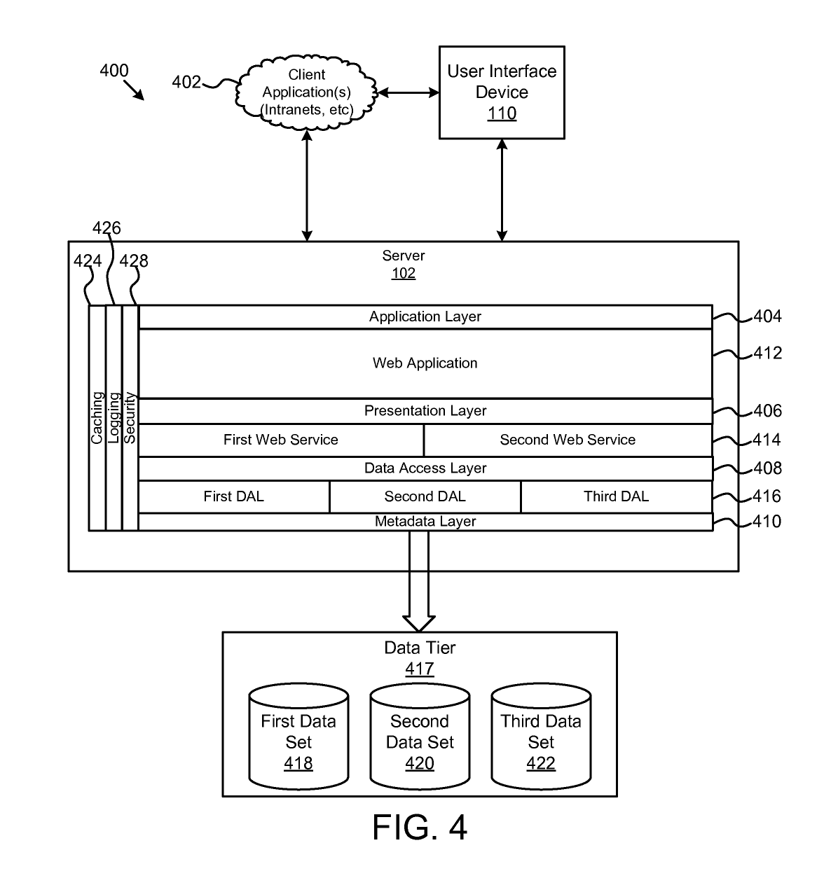

FIG. 4 illustrates one embodiment of a network-based system 400 for tracking, managing, and analyzing hospital privileges through the use of specifically researched content in conjunction with ICD, CPT or other codes. In one embodiment, the network-based system 400 includes a server 102. Additionally, the network-based system 400 may include a user interface device 110. In still a further embodiment, the network-based system 400 may include one or more network-based client applications 402 configured to be operated over a network 108 including an intranet, the Internet, or the like. In still another embodiment, the network-based system 400 may include one or more data storage devices 104.

The network-based system 400 may include components or devices configured to operate in various network layers. For example, the server 102 may include modules configured to work within an application layer 404, a presentation layer 406, a data access layer 408 and a metadata layer 410. In a further embodiment, the server 102 may access one or more data sets 418-422 that comprise a data layer or data tier 417. For example, a first data set 418, a second data set 420 and a third data set 422 may comprise a data tier 417 that is stored on one or more data storage devices 202-208.

One or more web applications 412 may operate in the application layer 404. For example, a user may interact with the web application 412 though one or more I/O interfaces 312-316 configured to interface with the web application 412 through an I/O adapter 310 that operates on the application layer. In one particular embodiment, a web application 412 may be provided for tracking, managing, and analyzing hospital privileges through the use of specifically researched content in conjunction with ICD, CPT or other codes that includes software modules configured to perform the steps of accessing the dataset of predefined medical service provider privileges, accessing the dataset of billing information, the billing information including one or more billing codes that are correlated to the predefined medical service provider privileges, assigning a set of one or more of the medical service provider privileges to a medical service provider, tracking billing information associated with the medical service provider, and updating the set of one or more of the medical service provider privileges assigned to the medical service provider in response to the billing information.

In a further embodiment, the server 102 may include components, devices, hardware modules, or software modules configured to operate in the presentation layer 406 to support one or more web services 414. For example, a web application 412 may access or provide access to a web service 414 to perform one or more web-based functions for the web application 412. In one embodiment, a web application 412 may operate on a first server 102 and access one or more web services 414 hosted on a second server (not shown) during operation.

For example, a web application 412 may access a first web service 414 for accessing a master list of privileges and a second web service 414 for accessing billing information. The web services 414 may receive requests for privilege assignments from medical service providers, assignments of privileges from medical facilities, etc. In response, the web service 414 may return data notifications of privilege assignments, updates, etc. One of ordinary skill in the art will recognize various web-based architectures employing web services 414 for modular operation of a web application 412.

In one embodiment, a web application 412 or a web service 414 may access one or more of the data sets 418-422 through the data access layer 408. In certain embodiments, the data access layer 408 may be divided into one or more independent data access layers 416 for accessing individual data sets 418-422 in the data tier 417. These individual data access layers 416 may be referred to as data sockets or adapters. The data access layers 416 may utilize metadata from the metadata layer 410 to provide the web application 412 or the web service 414 with specific access to the data set 412.

For example, the data access layer 416 may include operations for performing a query of the data sets 418-422 to retrieve specific information for the web application 412 or the web service 414. In a more specific example, the data access layer 416 may include a query for billing data, privilege assignments, code correlations with privileges, etc.

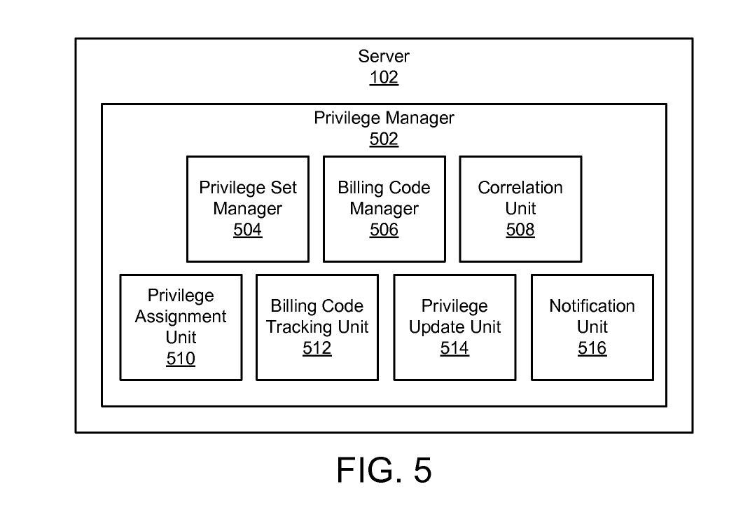

FIG. 5 illustrates a further embodiment of an apparatus for tracking, managing, and analyzing hospital privileges through the use of specifically researched content in conjunction with ICD, CPT or other codes. In an embodiment, the apparatus comprises a server 102. One of ordinary skill will recognize alternative embodiments, such as compute node(s) 116. In an embodiment, the server 102 may operate according to a privilege manager application 502. The privilege manager application may include a privilege set manager 504, a billing code manager 506, a correlation unit 508, a privilege assignment unit 510, a billing code tracking unit 512, a privilege update unit 514, and a notification unit 516. In an embodiment, the privilege manager application 502 may access the dataset of predefined medical service provider privileges, access the dataset of billing information, the billing information including one or more billing codes that are correlated to the predefined medical service provider privileges, assign a set of one or more of the medical service provider privileges to a medical service provider, track billing information associated with the medical service provider, and update the set of one or more of the medical service provider privileges assigned to the medical service provider in response to the billing information.

In an embodiment, such a system may be installed with pre-loaded privileging content that includes details of basic education requirements for a privilege(s). The system may also be installed with pre-loaded privileging content that includes a list of privileges, by specialty, that are normally given to health workers that can demonstrate the basic education requirement. Further, the system may be installed with pre-loaded privileging content that includes special procedures that require training in excess of the basic education or that require conditions such as proctoring or other restrictions. Additionally, the system may be installed with pre-loaded privileging content that includes detailed information called ‘threshold criteria’ that describe the training and conditions of the special privileges.

The privilege set manager 504 accesses the dataset of predefined medical service provider privileges, which may be stored on data storage device 104, cloud storage 118, or the like. In an embodiment, the predefined medical service provider privileges are pre-loaded in a master privilege database. The privilege set manager 504 may access the dataset via a database query language such as SQL, or the like. Alternatively, the privilege set manager 504 may communicate with a remote cloud-based dataset via Extensive Markup Language (XML) or the like. Additionally, the privilege set manager 504 may provide an interface for receiving annotations or restrictions to be placed on health care worker privileges.

In an embodiment, a local database of privileges may be created based on the master privilege database. In such an embodiment, the user may be able to partially or fully edit and modify the privileges for custom or specific policies of the medical facility. Such an embodiment is useful, because it allows for greater flexibility, but still maintains a base master set of privileges which can be used for backup or restoration of privileges in the case of a configuration error, data loss, etc. In such an embodiment, the privilege set manager 504 may track versions or changes to the set of privileges, which may be used for auditing, backup, restore, error remediation, and the like. In an embodiment, the privilege set manager 504 and/or the billing code manager 506 may generate a display of the differences between the master list of privileges and/or billing codes and any local copy.

The billing code manager 506 accesses the dataset of billing information, the billing information including one or more billing codes that are correlated to the predefined medical service provider privileges. In one embodiment, the billing information may be stored in a billing code database. The billing code information used for initial configuration of the system is not the same as the billing data used for tracking and updating the privileges. Rather, the billing information accessed by the billing code manager 506 is simply a list of billing codes which may be correlated to the privileges for the purpose of future tracking.

In an embodiment, the correlation unit 508 may correlate the billing codes managed by the billing code manager 506 with privileges, such that future billing under certain billing codes by a medical service provider can be tracked, recorded, logged, or otherwise stored and then checked against the privileges assigned to the service provider for updating of privilege statuses.

In still another embodiment, the privileges database, may be controlled and maintained by remote subject matter experts outside of the medical facility. In such an embodiment, requests for changes to privileges may be submitted by a user via the privilege set manager 504, but reviewed and ultimately implemented by an external privileges manager who specializes in compliance with certain governmental or professional standards, etc. Similarly, the external specialist may maintain the billing code database and the correlations.

The privilege assignment unit 510 may assign a set of one or more of the medical service provider privileges to a medical service provider. For example, a medical service provider may submit a request for privileges to perform certain procedures in the medical facility. A user, such as a privileges administrator, may review the request using a Graphical User Interface provided by the privilege assignment unit 510, and then make assignments by interacting with the GUI. For example, a list of core and specialty privileges which correspond to the medical service provider's profile information entered during the request may be automatically generated and displayed to the user for selection. In an embodiment, selection may include a simple radio style or check box style selection in some embodiments. One of ordinary skill will recognize a variety of suitable GUI designs which may be implemented for interface with the user and for assignment of the privileges by the privilege assignment unit 510. In an embodiment, the privilege assignment unit 510 may then store the set of assigned privileges in association with the medical service provider records in a database.

In a further embodiment, privileges may be assigned in one or more varying levels. For example, a new service provider may be assigned provisional privileges pending a period of review. Other statuses may include probationary privileges pending a period of conduct or performance review, or restricted privileges provided for retired or contract service providers. One of ordinary skill will recognize a variety of desirable privilege statuses.

In various embodiments, demographic information associated with the medical service provider may be maintained by the system. Beneficially, such information may be used to identify the medical service provider and to verify privileges at the time that a service is to be provided. For example, in a surgical setting, a responsible nurse or administrator may be provided with a picture, and other demographical information for identification of the medical service provider before authorizing the service provider to perform a procedure on a patient. Further, a list of privileges assigned to the medical service provider may be displayed for verification that the medical service provider is authorized to perform a specific procedure. In still other embodiments, orders or records for a medical procedure to be performed may be entered and automatically cross-checked by the system. In such an embodiment, the system may simply provide

The billing code tracking unit 512 may track billing information associated with the medical service provider. In an embodiment, the billing code tracking unit 512 may interface with various billing systems in order to extract procedure information. In such an embodiment, the billing information may be used to keep track of procedures performed by health care workers in order to analyze worker performance or requirements with respect to privileging.

The privilege update unit 514 may update the set of one or more of the medical service provider privileges assigned to the medical service provider in response to the billing information. In an embodiment, the privilege update unit 514 tracks the dates privileges were granted and/or expire for health care workers. Additionally, the privilege update unit 514 may track the expiration of privileges and alerts the user of the impending expirations. In still other embodiments, certain thresholds on the number of procedures performed within a time period may be set. For example, if a service provider performs more than a minimum threshold number of a particular procedures within a provisional privileges period, then the provisional privileges may be automatically converted into standard or regular privileges. Similarly, if the number of a particular type of procedures performed falls below a threshold value over the course of a service provider's career, those privileges may be automatically removed. Alternatively, those privileges may be converted into a probationary or temporary status pending further review by an administrator.

In an embodiment, the notification unit 516 may generate notifications to the medical service provider, to a hospital administrator, or to an external administrator in response to certain operations performed by the system. For example, the notification unit 516 may generate an email or text message notification when a service provider has submitted a request for privileges. Similarly, the notification unit 516 may generate a notification to the service provider when the privileges have been granted. The notification may include a description or listing of the privileges, and in some embodiments, a listing of codes and a description of any thresholds or time periods associated with the privileges.

In various embodiments, the privileges management application 502 may provide an interface to allow a user to search the system. For example, a service provider may search for a specific privilege or set of privileges. An administrator may search for a specific service provider to see a list of assigned privileges. Also, an administrator may search for a specific privilege or specific billing code to see correlations. One of ordinary skill may recognize additional searches, which may be beneficial in the industry. In such embodiments, the search results may be limited or restricted based on the role of the user. For example, a user may provide credentialing information when logging onto the system. The credentialing information may be associated with a user profile that specifies permissions for viewing various levels of details. For example, a service provider may be able to see a list of privileges assigned specifically to him, but not to any other service provider. A low level administrator may be able to see privileges for the purpose of assignments, but may not be able to edit or modify privileges. An upper level administrator may be provided full access to the local databases, etc. An external administrator may be granted permission to access the master databases, etc.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 6 illustrates one embodiment of a method 600 for tracking, managing, and analyzing hospital privileges through the use of specifically researched content in conjunction with ICD, CPT or other codes. In one embodiment, the method 600 starts with accessing a dataset of predefined medical service provider privileges, as shown at block 602. The method 600 may also include accessing a dataset of billing information, the billing information including one or more billing codes that are correlated to the predefined medical service provider privileges, as shown at block 604. The method 600 may further include assigning a set of one or more of the medical service provider privileges to a medical service provider, as shown at block 606. At block 608, the method may include tracking billing information associated with the medical service provider. At block 610, the method may include updating the set of one or more of the medical service provider privileges assigned to the medical service provider in response to the billing information.

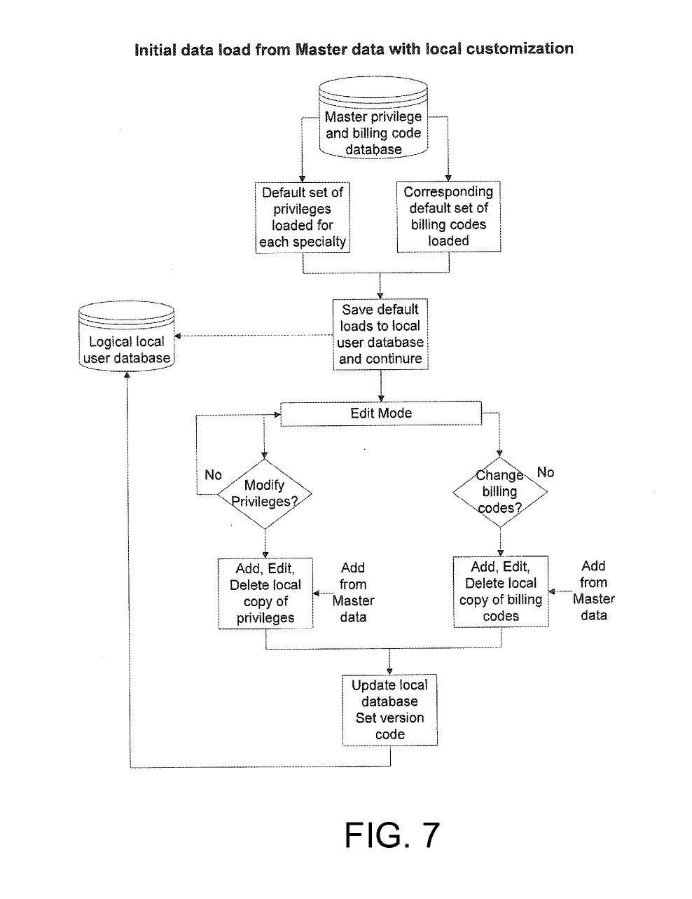

FIG. 7 illustrates an embodiment of an initial data setup operation. In the described embodiment, data may be accessed from a master privilege and billing code database, to retrieve a default set of privileges for each specialty and a corresponding default set of billing codes. The defaults may be saved to the system as a local database. If the user elects to simply use the default set, then the defaults become the operational set of privileges and billing codes stored in the logical local database. If not, then an edit mode may be entered and the user may modify privileges, modify billing codes, and modify correlations. In such an embodiment, the updated set of privileges and codes may be loaded to the logical local database. In the described embodiment, a version code may be recorded for tracking of versions of the local database.

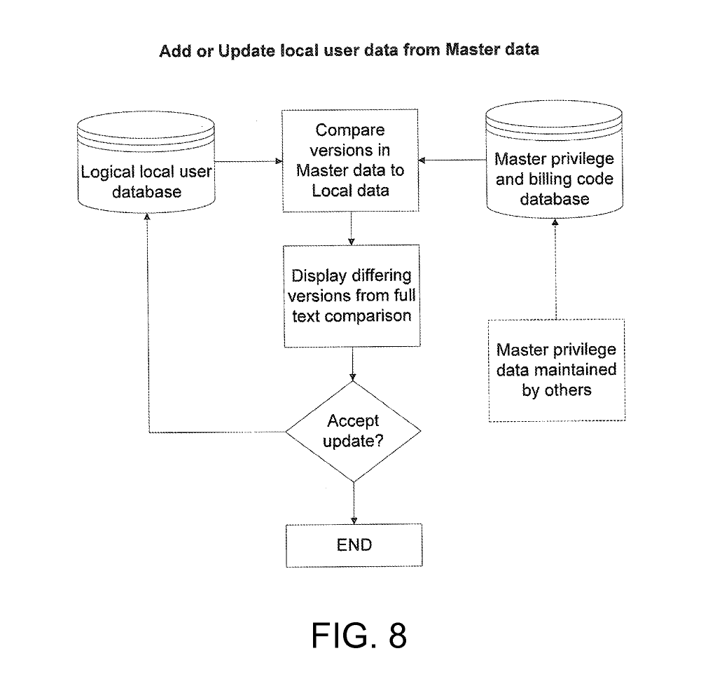

FIG. 8 illustrates a method for reviewing added or updated local user data. In the illustrated embodiment, the master privileges and billing codes may be compared with a version of the logical local database, and the differences may be displayed. If the user accepts the update, then the changes may be saved to the logical local user database.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A system comprising:
a data storage unit configured to store:
a dataset of predefined medical service provider privileges;
a dataset of billing information, the billing information that is correlated to the predefined medical service provider privileges; and
a data processor configured to:
access the dataset of predefined medical service provider privileges;
access the dataset of billing information, the billing information including one or more billing codes that are correlated to the predefined medical service provider privileges;
assign a set of one or more of the medical service provider privileges to a medical service provider;
track billing information associated with the medical service provider; and
update the set of one or more of the medical service provider privileges assigned to the medical service provider in response to the billing information.

2. The system of claim 1, wherein the dataset of billing information further comprises a billing code that are correlated with the medical service provider privileges.

3. The system of claim 2, wherein the data processor is configured to modify the correlation of the set of one or more billing codes with the medical service provider privileges.

4. The system of claim 3, further comprising an interface for allowing a user to modify the set of one or more billing codes associated with the medical service provider privileges.

5. The system of claim 1, further comprising an interface for allowing a user to modify one or more of the medical service provider privileges.

6. The system of claim 1, wherein assigning the set of one or more of the medical service provider privileges further comprises assigning a default set of medical service provider privileges in response to a service provider profile.

7. The system of claim 6, wherein the data processor is further configured to update the default set of medical service provider privileges assigned to the service provider in response to the billing information.

8. The system of claim 7, wherein the data processor is further configured to automatically track billing codes associated with the medical service provider over a period of time to determine a number of procedures and a type of procedures performed by the medical service provider.

9. The system of claim 8, wherein updating further comprising granting privileges in response to a determination that the number of procedures performed by the medical service provider exceeds a threshold number of procedures.

10. The system of claim 8, wherein updating further comprising restricting privileges in response to a determination that the number of procedures performed by the medical service provider is below a threshold number of procedures.

11. The system of claim 1, wherein the data processor is further configured to automatically generate a notification in response to updating the set of one or more medical service provider privileges assigned to the medical service provider.

12. A method comprising:
accessing a dataset of predefined medical service provider privileges stored on a data storage unit;
accessing a dataset of billing information, the billing information that is correlated to the predefined medical service provider privileges stored on a data storage unit;
assigning a set of one or more of the medical service provider privileges to a medical service provider with a data processor;
tracking billing information associated with the medical service provider with the data processor; and
updating the set of one or more of the medical service provider privileges assigned to the medical service provider in response to the billing information with the data processor.

13. The method of claim 12, wherein the dataset of billing information further comprises a billing code that are correlated with the medical service provider privileges.

14. The method of claim 13, further comprising modifying the correlation of the set of one or more billing codes with the medical service provider privileges.

15. The method of claim 14, further comprising providing an interface for allowing a user to modify the set of one or more billing codes associated with the medical service provider privileges.

16. The method of claim 12, further comprising providing an interface for allowing a user to modify one or more of the medical service provider privileges.

17. The method of claim 12, wherein assigning the set of one or more of the medical service provider privileges further comprises assigning a default set of medical service provider privileges in response to a service provider profile.

18. The method of claim 17, further comprising updating the default set of medical service provider privileges assigned to the service provider in response to the billing information.

19. The method of claim 18, further comprising automatically tracking billing codes associated with the medical service provider over a period of time to determine a number of procedures and a type of procedures performed by the medical service provider.

20. The method of claim 19, wherein updating further comprising granting permanent privileges in response to a determination that the number of procedures performed by the medical service provider exceeds a threshold number of procedures.

21. The method of claim 19, wherein updating further comprising restricting privileges in response to a determination that the number of procedures performed by the medical service provider is below a threshold number of procedures.

22. The method of claim 12, further comprising generating a notification in response to updating the set of one or more medical service provider privileges assigned to the medical service provider.
